(19) United States
(12) Patent Application Publication
(10) Pub. No.: US 2007/0168430 A1
(43) Pub. Date: Jul. 19, 2007

(54) Content-based dynamic email prioritizer

(75) Inventors: Caroline Brun, Grenoble (FR); Caroline Hagege, Grenoble (FR)

Correspondence Address: Patrick R. Roche;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/287,170

(22) Filed: Nov. 23, 2005

(51) Int. Cl. G06F 15/16

(52) U.S. Cl. 709/206

(57) ABSTRACT

An email organizer operates in conjunction with an email system (20) and a natural language processor (42, 44). An action deadline detector (50) detects action deadlines contained in email messages (30) based on syntactic information about the email messages provided by the natural language processor. A scorer (56) assigns priority scores to the email messages based at least on the action deadlines and a current date (58).

### BACKGROUND

The following relates to the information processing arts. It is described with reference to example applications for email prioritization. However, the following is amenable to other like applications.

Electronic mail, more commonly referred to as email, is ubiquitous in modern businesses, government agencies, and organizations, and is rapidly becoming just as common in domestic settings. A typical email user receives several emails, several dozen emails, or even hundreds of emails each day, which accumulate in the user's inbox or other incoming email repository. Accordingly, it is desirable to have automated assistance in managing incoming email messages.

Heretofore, one approach for managing emails has been to allow the sender to attach a priority flag, priority index, or other priority indicator to an email message. Thus, for example, the sender can tag a message as having “high importance”, “medium importance”, or “low importance” based on the sender's assessment of the message content. This approach has the disadvantage that the importance is set by the sender, not by the recipient, who may have a very different assessment of the importance of the message. Moreover, the sender must take affirmative action in order to tag the email message with anything other than a default message priority.

Another common approach for managing email messages is to filter the messages based on the sender's identity, keywords in the email message subject header, keywords in the body text of the email message, or so forth. For example, so-called spam filters move incoming email messages that appear to be commercial advertisements, scams, pyramid schemes, or the like into a designated folder or other repository. The user typically can configure the filter to specify specific sender names or keywords for use in filtering. Filtering can also be used to identify especially important messages based on sender name or keywords, and such important messages are collected in a designated folder or otherwise processed for expedited review by the recipient. Filtering of email messages based upon sender or keywords has certain deficiencies. It does not distinguish the importance or unimportance of messages from a given sender. For example, a filter may be set up to assign high importance to messages from co-workers, but not all messages from co-workers are in fact important to the recipient. Conversely, an email message from a sender whose messages are usually unimportant may in certain instances be very important.

Another problem with existing email prioritization is that the priority assignment is static. For example, a sender may send an email message tagged by the sender as low priority because the message calls for the recipient to take an action at some date far in the future. This email message is then stored as a low priority message in the recipient's inbox or other folder. As time goes by, the low priority message is buried by more recently incoming email messages (assuming the email folder is sorted by message receipt date), and the busy recipient forgets about it. The deadline for taking the action passes, and problems arise.

### BRIEF DESCRIPTION

According to certain aspects set forth herein, an email organizer is disclosed. A syntactic processor performs syntactic analysis on a plurality of email messages to determine action deadlines associated with action items specified in the email messages. A scorer assigns priority scores to the email messages based at least on the determined action deadlines and a current date.

According to certain aspects set forth herein, a method is disclosed for prioritizing email. A plurality of email messages are analyzed to determine action deadlines contained in the email messages. The email messages are processed based at least on the determined action deadlines.

According to certain aspects set forth herein, an email organizer is disclosed which operates in conjunction with an associated email system and an associated natural language processor. An action deadline detector detects action deadlines contained in email messages based on syntactic information about the email messages provided by the associated natural language processor. A scorer assigns priority scores to the email messages based at least on the action deadlines and a current date.

### BRIEF DESCRIPTION OF THE DRAWINGS

FIG. 1 diagrammatically shows an email system including content-based email message prioritization.

FIG. 2 plots message priority as a function of current date, for a message having an action deadline of “Friday”.

### DETAILED DESCRIPTION

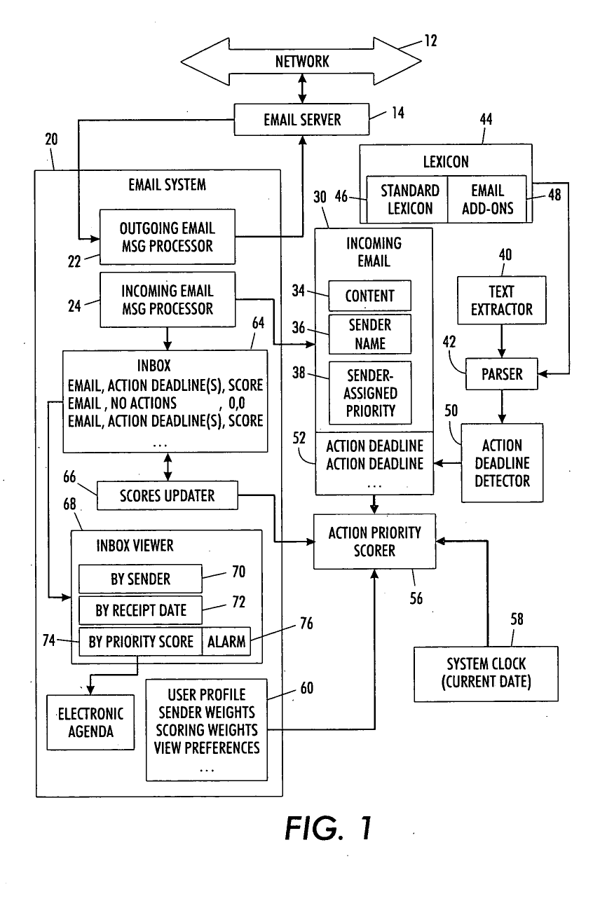

With reference to FIG. 1, a network 12, such as the Internet, a local area network, a corporate data network, or so forth, serves as an electronic conduit for electronic mail (email) messages. In some embodiments, the network 12 may include multiple levels or branches. For example, the network 12 may include at least one corporate local area network (LAN) that also links the LAN users with the Internet via a suitable firewall or other security mechanism. Although not illustrated, the network 12 typically interconnects a number of users, for example all employees of a corporate network, all customers of an Internet Service Provider (ISP), users from around the world in the case of the Internet, or so forth, who selectively exchange email messages.

An email server 14 is operatively connected with the network 12 to route incoming and outgoing email messages. The email server 14 may route email messages for a number of users. In some embodiments, such as a closed-universe corporate server, the email server 14 may serve the same group of users as the network 12. In other embodiments, the email server 14 may serve a sub-set of the group of network users. For example, an ISP email server may serve only the ISP customers, while the Internet serves a far larger group of users.

An example user manages his or her email using an email system 20 operatively connected with the email server 14. The email system 20 includes an outgoing email processor 22 through which the user composes and sends outgoing email messages. In some embodiments, the outgoing email processor 22 invokes an external word processor, image editor, or other associated software (not shown) that assist in composing the outgoing email message. Optionally, the email message includes attachments, which are files such as word processing files, presentation files, digital images, or so forth that are associated with the email message and which are routed with the email message from the sender to the recipient. The outgoing email processor 22 sends the outgoing email message to the email server 14 which configures the outgoing email message for transmission via the network 12, for example by adding email headers and so forth that conform the email message to transmission standards employed by the network 12.

The email system 20 further includes an incoming email processor 24 that receives and processes incoming email messages routed to the user by the email server 14. The incoming email processor 24 performs initial processing of the incoming email message, such as extracting header information such as sender name, sender-assigned priority, or so forth. Optionally, the incoming email processor 24 may perform filtering such as spam filtering to identify messages of low and/or high importance for special processing. The filtering employs suitable filtering criteria, such as sender name, keywords contained in the message, or so forth, which are optionally set up by the user. Email messages are destined for the user's inbox 26, as illustrated, or may be destined for another email folder selected by the filtering.

After initial processing, the incoming email messages are prioritized. As an illustrative example, a pre-processed incoming email message 30 output by the incoming email processor 24 includes email message content 34 and suitable tags such as the sender name 36, sender-assigned priority 38, or so forth. The content 34 typically includes, for example, header information, such as the subject of the email message, and text of the email message. The content 34 optionally also includes content of email attachments such as attached word processing files, presentation files, portable document format (pdf) files, or so forth.

A text extractor 40 extracts text from the content 34. If the content 34 is purely text, then the text extractor 40 is optionally omitted. However, in embodiments in which the content 34 may include attachments such as word processing documents, presentation files, portable document format (pdf) files, or so forth, or where the content is in a marked-up or otherwise annotated format such as HTML, the text extractor 40 extracts content text from the attachments or annotated content using algorithms suitable for the particular format of the attachment or annotation scheme. In some cases, an email attachment may be non-text-based, such as an image file, or may be in a format not supported by the text extractor 40. Such cases are suitably handled by not including the unreadable attachment in the content-based prioritization. Optionally, the user may be provided with a warning that the attachment was unreadable and hence unprocessed by the email system.

A parser 42 performs natural language processing of the extracted textual content of the email message 30. In some embodiments, the parser 42 employs syntactic analysis, such as deep syntactic analysis disclosed for example in Caroline Brun and Caroline Hagege, “Normalization and paraphrasing using symbolic methods” ACL: Second International workshop on Paraphrasing, Paraphrase Acquisition and Applications, Sapporo, Japan, Jul. 7-12, 2003 employing robust parsing disclosed for example in Salah Aït-Mokhtar, Jean-Pierre Chanod, and Claude Roux, “Robustness beyond shallowness: incremental dependency parsing,” in special issue of the NLE Journal (2002). These example natural language processing techniques are well suited for analysis of email content which can sometimes be grammatically informal or can use a telegraphic style that does not employ grammatically complete sentences and paragraphs. Other natural language processing or parsing algorithms can be used.

The parsing is used to identify action deadlines associated with action items in which the recipient is the agent who is to perform the action item. Deep syntactic analysis processing of sentences is suitably used to identify actions verbs indicative of action items, and to identify content setting forth action items in which the email message recipient is the designated agent for performing the action item. It is to be appreciated that in natural language content the agent is not necessarily expressed as the subject of a finite verb. For example, in the content: “We expected you to send us the report” the verb “send” is in an infinitive form. Deep syntactic processing suitably recognizes the infinitive form and determines that the agent for sending the report is the email message recipient who corresponds to the pronoun “you” in this context. More generally, deep syntactical analysis enables processing of various complex linguistic forms to identify the agent. Deep syntactic analysis enables determination of action items in which the recipient email user is expected to do something. For example, deep syntactic analysis may employ lexical semantics associated to predicates that appears in text and linguistic links between those predicates and linguistic objects that denote the user, such as to identify “you” in the previous example as the recipient email user.

The parser 42 accesses a lexicon 44 in performing the parsing. The lexicon typically includes a standard lexicon component 46 suitable for the natural language in which the email message content 34 is written. For example, if the email message content 34 is written in English, then the standard lexicon component 46 is a standard English lexicon. Additionally, the standard lexicon component 46 may include entries particularly related to typical subject matter of email messages received by the user. For example, if the user is a physicist, the standard lexicon component 46 may include entries particularly related to the subject of physics, so as to enable more effective parsing by the parser 42. In other words, the “standard” lexicon 46 may be a standard lexicon for a physicist or other specialist or specialized field.

Still further, the lexicon 44 optionally includes email add-on components 48 providing entries particularly related to email processing or to identification of action items and action deadlines. The add-ons 48 optionally include typical action deadline phrases, such as “by the end of the month”, “end-of-quarter”, “end of fiscal year”, or so forth. Moreover, the add-ons 48 optionally include organization-specific entries, such as the names of specific corporate projects or committees, or so forth, that may be expected to be used in connection with action items.

An action deadline detector 50 examines the parsing to identify action deadlines associated with action items. The content analysis performed by the parser 42 is computationally intensive. Moreover, the email message content is typically static and does not change with time. Accordingly, it is advantageous to store the action deadlines identified by the deadline detector 50 as action deadline tags 52 associated with the pre-processed email message 30. Optionally, the action items associated with the detected action deadlines are also stored as tags associated with the pre-processed email message 30. In another approach, an action item classification or type can be stored as a tag associated with each action deadline.

As an example of natural language processing content analysis for extracting action deadlines, the following email text portion:

. . .
Hello, this is to ask if you would be willing to serve as
program chair for Symposium W of the Third Annual ABCD
Conference.
. . .
The deadline for abstract submissions for this Conference
is set for Feb. 26, 2006. We would like to have
program chairs established before this date.
. . .

is analyzed to identify an action item “serve as program chair” which the deep syntactic analysis identifies as an action item to be performed by the email message recipient based on the contextually associated pronoun “you”. Additionally, linguistic associations between the term “program chair” and the date “February 26, 2006” are used by the natural language processing to connect the action deadline of Feb. 26, 2006 and the action item “serve as program chair.” Thus, the action deadline “February 26, 2006” is detected by the action deadline detector 50 along with the associated action item “serve as program chair.” As another example, the following email header and text portion:

| | |
|---|---|
| From: | Joe Smith |
| To: | Jane Doe |
| Subject: | ABC Roundtable for Monday, 7 March 2006 |

This is an invitation to attend the ABC Roundtable addressing . . .

is analyzed as follows. Syntactic analysis of the content of the body of the email identifies the action item “attend the ABC Roundtable” as an action item in which the email recipient is the agent expected to perform the action item. Syntactic analysis of the “Subject” header of the email then connects the date “March 7, 2006” with the action item “attend the ABC Roundtable”. Thus, the action deadline “March 7, 2006” is detected by the action deadline detector 50 along with the associated action item “attend the ABC Roundtable.”

An action priority scorer 56 assigns a priority score to the incoming email message 30 based on at least the action deadline tags 52 and a current date 58, for example supplied by a system clock. In one approach, the priority score is assigned as a temporal difference between the action deadline and the current date, measured for example in units of days. However, more complex scoring formulae can be applied. For example, the scoring formula can take into account the sender-assigned priority 38, or can take into account the sender identity 36 based on sender weights stored in a user profile 60 of the email system 20. One suitable example scoring formula is:

$$Score = \{ \begin{matrix}\frac{{W}_{a} \cdot {W}_{s} \cdot {W}_{SP}}{AD - CD} , & AD > CD \\ {W}_{a} \cdot {W}_{s} \cdot {W}_{SP} \cdot 100 , & AD = CD \\ 0 , & No AD ,\end{matrix} \qquad ( 1 )$$

where AD is the action deadline, CD is the current date, Wₐ is an action weight stored in the user profile 60 for the type of action item corresponding to the action deadline AD, Wₛ is a sender weight stored in the user profile 60 for the sender of the email message, and W_{SP} is the sender-assigned priority. The priority score of Equation (1) assigns a relatively larger score to email messages having an action deadline that is relatively closer to the current date, since in this case the denominator (AD−CD) decreases. The difference (AD−CD) is suitably measured as a number of days, although other measures such as a number of hours or a number of weeks can be used instead. If the action deadline equals the current date (that is, the action item is due “today”), then the priority score of Equation (1) assigns a specially large score to the email message through the large scaling factor of 100 (or another large number) applied when AD=CD. If the email message has no associated action deadlines, then the priority score of Equation (1) assigns the email message a default score of zero (or another low value). If an email message has more than one associated action deadline, the shortest action deadline is suitably used in Equation (1).

The action score formula of Equation (1) does not provide a priority score formula component for the case in which the action deadline is in the past, that is, for AD<CD. In some embodiments, a past-due action deadline tag is removed from the email message, such that AD≧CD in all cases.

In other embodiments, past-due action deadlines are retained and incorporated into the priority scoring. For example, the absolute value of the difference between the action deadline and the current date |AD−CD| can be used, such as in the following example scoring formula:

$$Score = \{ \begin{matrix}\frac{{W}_{a} \cdot {W}_{s} \cdot {W}_{SP}}{\vert AD - CD \vert} , & AD \neq CD \\ {W}_{a} \cdot {W}_{s} \cdot {W}_{SP} \cdot 100 , & AD = CD \\ 0 , & No AD ,\end{matrix} \qquad ( 2 )$$

where |.| indicates absolute value. In this case, the priority score increases as the current date approaches the deadline, peaks when the current date equals the action deadline, and symmetrically decreases as the current date passes the action deadline. The priority score of Equation (2) provides the user both with advance warning of the approaching action deadline and a period of continued warning of the past-due action deadline, the latter providing the user an opportunity to remedy the missed deadline.

It is to be appreciated that the scoring formulae of Equations (1) and (2) are examples. Other scoring formulae can be used. Various approaches can be used for email messages having more than one action deadline. In the method of Equation (1), for example, the shortest action deadline is suitably used and any later action deadlines are ignored. In the method of Equation (2), the closest action deadline to the current date (as measured by absolute value) can be used. In other embodiments, the score is suitably enhanced for email messages having more than one action deadline, or is enhanced for email messages having more than a threshold number of action deadlines. This can advantageously enhance the priority score of email messages which include a long list of action items for the recipient to perform.

The action weight Wₐ is optionally omitted from the scoring formula of Equation (1), in which case all action items are treated equally regardless of the type of action involved. Incorporating action weights Wₐ allows the scoring to take into account the importance or type of action. For example, in a business setting a higher action weight may be assigned for important action items such as deliveries of shipments to customers as compared with action items of lesser importance. Also, the action weight may be made larger for action items having mandatory action deadlines than for action deadlines having recommended or non-mandatory deadlines. Similarly, the sender weight Wₛ is optionally omitted from the scoring formula of Equation (1), in which case all action items are treated equally regardless of who sent the email message. Incorporating sender weights Wₛ allows the scoring to take into account the importance of the sender. For example, an action deadline set by an email message sent by the user's immediate supervisor may be assigned a higher sender weight than an action deadline set by an email message sent by a subordinate. Similarly, the sender-assigned priority W_{SA} is optionally omitted from the scoring formula of Equation (1), in which case any sender-assigned priority is disregarded in assigning the priority score. Various additional or other email message parameters can be incorporated into the scoring formula, such as the message length (under the expectation that a longer message may be more important).

The email message, optionally including the action deadline tags 52, is suitably stored in an illustrated inbox 64 or in another designated folder. A scores updater 66 tags each stored email with its priority score calculated by the action priority scorer 56. An inbox viewer 68 enables the user to view the list of email messages stored in the inbox 64 sorted by a selected sorting criteria, such as a “by sender” sorting criterion 70, a “by receipt date” sorting criterion 72, or a “by priority score” sorting criterion 74. The “by priority score” sorting criterion 74 sorts the email messages by the priority scores assigned to the email messages by the action priority scorer 56. Optionally, the inbox viewer 68 includes an alarm 76 that distinctively sets forth any email message having an action deadline corresponding to the current date 58, for example by video highlighting, flashing text, a voice-synthesized warning, or so forth. Alternatively, the alarm 76 can be triggered by a priority score greater than a threshold value, which may for example provide a special alert to the user a day or two before the action deadline comes due. In some embodiments, email messages which do not have any associated action deadlines are omitted from the “by priority score” view 74. In other embodiments, email messages which do not have any associated action deadlines are listed at the bottom of the “by priority score” view 74.

It is advantageous to occasionally apply the scores updater 66 to update the priority scores of the email messages. In the illustrated embodiment, each email message stored in the inbox 64 is tagged with any associated action deadlines. Accordingly, it is straightforward to re-apply the action priority scorer 56 to each message applying, for example, the scoring formula of Equation (1) or of Equation (2), without re-analyzing the content of the email messages each time the priority score is recalculated. The scores updating can be performed at various times, such as whenever the current date 58 increments by a day (or by an hour or other time metric used in computing the priority score). The scores are optionally updated each time the inbox viewer 68 is accessed by the user.

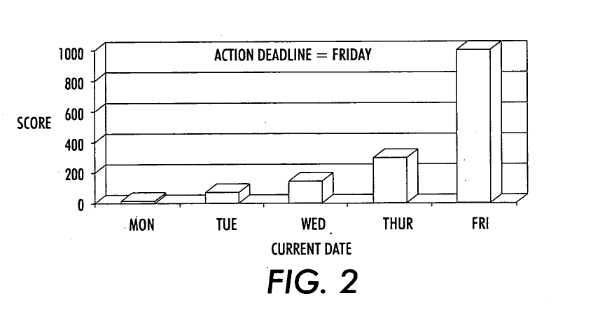

With reference to FIG. 2, the occasionally updated priority score of a given email message can be expected to generally increase as the current date 58 progresses toward the action deadline associated with that email message. FIG. 2 diagrammatically plots the priority score for an email message having an action deadline of Friday for current dates within one week of the Friday action deadline. On Monday, the denominator (AD−CD) of Equation (1) equals four days, and so a relatively low priority score is assigned. In contrast, on Thursday, the denominator (AD−CD) equals one day, leading to a substantially higher priority score. The priority score is largest on Friday, that is, on the “due date”. For Saturday (not plotted in FIG. 2), the priority score goes to zero when using Equation (1) since the past-due action deadline tag is removed. On the other hand, for Saturday the priority score goes to the same value as for Thursday when using Equation (2) since the past-due action deadline is again one day away from the due date, albeit one day past due.

In some embodiments, the tagged action deadlines and priority scores are transparent to the user. In other embodiments, these tags are shown to the user by the inbox viewer 68. In such latter embodiments, the user optionally has the ability to remove an action deadline tag, for example once the user has completed the associated action item or when the associated action item becomes unnecessary for whatever reason. When an action deadline tag is removed, the scores updater 66 preferably updates the score for that email message to reflect removal of the action deadline, typically resulting in a lowered priority score. This enables the “by priority score” view 74 to better focus the user's attention on the remaining action items. In a similar manner, the user optionally has the ability to modify or add an action deadline tag to an email message.

The terms “email” and “email message” as used herein are intended to be broadly construed as encompassing the illustrated personal electronic mail and personal electronic mail messages (optionally including any email attachments), and additionally to encompass electronic mail and electronic mail messages posted on other types of electronic forums for communicating electronic messages insofar as such messages may include action deadlines for performing associated action items. Such other electronic forums may include, for example: electronic message boards and messages thereon; electronic newsgroups and electronic newsgroup messages; listgroups and listgroup messages; and so forth. As another example, a university professor, high school teacher, or other instructor may establish a message board accessible via a school computer system, and/or accessible via the Internet, for posting class-related messages, some of which may include action deadlines such as class assignment deadlines, field trip dates, and so forth. These messages are suitably deemed to be email messages and are readily prioritized based at least on the contained action deadlines using methods and apparatuses disclosed herein. The priority scoring of such messages optionally includes other criteria besides action deadlines, such as the identity of the posting party which corresponds to the sender weight Wₛ (for example, if both the instructor and students can post messages, then the scoring criteria optionally assigns a high sender weight to the instructor and a lower sender weight to students so that the priority scoring weights the score of messages posted by the instructor relatively higher than messages posted by students).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. (canceled)

2. An email organizer comprising:
a syntactic processor for performing syntactic analysis on a plurality of email messages to determine action deadlines associated with action items specified in the email messages;
a scorer that assigns priority scores to the email messages based at least on the determined action deadlines and a current date; and
a viewer setting forth the email messages sorted by priority score.

3. The email organizer as set forth in claim 2, wherein the viewer distinctively sets forth any email message having an associated action deadline equal to the current date.

4. The email organizer as set forth in claim 2, further comprising:
email storage storing email messages tagged with at least the assigned priority scores.

5. The email organizer as set forth in claim 2, further comprising:
email storage storing email messages tagged with at least the determined action deadlines.

6. The email organizer as set forth in claim 5, further comprising:
a scores updater that invokes the scorer to assign updated priority scores to the email messages based at least on the tagged action deadlines and an updated current date.

7. The email organizer as set forth in claim 2, further comprising:
an incoming email message processor that determines associated information other than action deadlines for incoming emails, the scorer assigning priority scores to the email messages based at least on the action deadlines and associated information other than action deadlines.

8. The email organizer as set forth in claim 7, wherein the associated information other than action deadlines determined by the incoming email message processor for incoming emails includes a sender name.

9. The email organizer as set forth in claim 7, wherein the associated information other than action deadlines determined by the incoming email message processor for incoming emails includes a sender-assigned email message priority.

10. (canceled)

11. The method as set forth in claim 20, further comprising:
assigning priority scores to the email messages based on at least the determined action deadlines, the processing including sorting the email messages by priority score.

12. The method as set forth in claim 11, wherein the assigning comprises:
assigning the priority scores to the email messages based on a shortest action deadline determined for each message referenced to a current date.

13. The method as set forth in claim 11, wherein the assigning comprises:
assigning the priority scores to the email messages based at least in part on a total number of action deadlines determined for each message.

14. The method as set forth in claim 11, wherein the assigning comprises:
assigning a lowest priority score to any email message for which no action deadlines are determined.

15. The method as set forth in claim 11, wherein the assigning comprises:
enhancing the priority score of any email message having an action deadline equal to the current date.

16. The method as set forth in claim 11, wherein the assigning comprises:
assigning the priority scores to the email messages based at least on the determined action deadlines and the action item associated with each determined action deadline.

17. The method as set forth in claim 11, wherein the assigning comprises:
assigning the priority scores to the email messages based at least on (i) the action deadlines and (ii) at least one other message parameter.

18. The method as set forth in claim 17, wherein the at least one other message parameter includes at least one other message parameter selected from a group consisting of (i) email message sender name and (ii) email message sender-assigned priority.

19. The method as set forth in claim 11, wherein the assigning further comprises:
updating the priority scores to reflect a change in the current date.

20. A method for prioritizing email, the method comprising:
performing syntactic analysis to determine the action deadlines associated with action items specified in the email messages; and
processing the email messages based at least on the determined action deadlines; and
presenting at least some processed email messages and an indication of at least some determined action deadlines to a user.

21. An email organizer operating in conjunction with an associated email system and an associated natural language processor, the email organizer comprising:
an action deadline detector that detects action deadlines contained in email messages based on syntactic information about the email messages provided by the associated natural language processor;
a scorer that assigns priority scores to the email messages based at least on the action deadlines and a current date; and
a viewer configured to set forth at least some email messages and an indication of at least some assigned priority scores.

22. The email organizer as set forth in claim 21, wherein the scorer assigns priority scores based on the action deadlines and the current date and further based on parameters of the email messages provided by the associated email system.

23. The email organizer as set forth in claim 21, wherein the scorer updates the priority scores to adjust for advancement of the current date.

24. The email organizer as set forth in claim 23, further comprising:
an alarm that distinctively sets forth an email message to an associated user when an action deadline associated with the email message equals the current date.
